(19) United States
(12) Patent Application Publication
(10) Pub. No.: US 2019/0315950 A1
(43) Pub. Date: Oct. 17, 2019

(54) LOW-SMOKE, NON-HALOGENATED FLAME RETARDANT COMPOSITION

(71) Applicant: EQUISTAR CHEMICALS, LP, HOUSTON, TX (US)

(72) Inventor: CHUN D. LEE, CINCINNATI, OH (US)

(73) Assignee: EQUISTAR CHEMICALS, LP, HOUSTON, TX (US)

(21) Appl. No.: 16/386,942

(22) Filed: Apr. 17, 2019

Related U.S. Application Data
(60) Provisional application No. 62/658,799, filed on Apr. 17, 2018.

(51) Int. Cl. C08L 23/08; C08L 51/00; C08K 3/016; C08K 3/22; C08K 3/26

(52) U.S. Cl. CPC C08L 23/0853; C08L 51/003; C08K 3/016; C08K 3/22; C08K 3/26; C08K 3/015; C08L 2205/025; C08L 2201/02; C08K 2003/2224; C08K 2003/2206; C08L 2314/06

(57) ABSTRACT

The present disclosure provides a low-smoke, non-halogenated flame retardant composition made from or containing (a) a first ethylene/vinyl acetate copolymer, having a total content of vinyl acetate-derived units in an amount from about 15 to about 45 weight percent, based upon the total weight of the ethylene/vinyl acetate copolymer; (b) a coupling agent; (c) magnesium dihydroxide; (d) hydromagnesite; and (e) huntite.

### CROSS-REFERENCE TO RELATED APPLICATIONS

This application is the Non-Provisional patent application, which claims benefit of priority to U.S. Provisional Application No. 62/658,799, filed Apr. 17, 2018, the contents of which are incorporated herein by reference in their entirety.

### FIELD OF THE INVENTION

In general, the present disclosure relates to the field of chemistry. More specifically, the present disclosure relates to a polyolefin-based composition useful as a flame-retardant composition. In particular, the present disclosure relates to a low-smoke, non-halogenated flame retardant composition useful for wire-and-cable applications.

### BACKGROUND OF THE INVENTION

Initially, flame retardant polymer compositions relied on halogens to yield flame retardancy. Because halogens produce very toxic and corrosive combustion products in fires, the focus shifted to the development of halogen-free, flame retardant (HFFR) or low-smoke zero-halogen (LSOH) compounds.

Polyolefins lack inherently good flame resistance. Additionally, the choice of halogen-free flame retardants has been limited to certain hydrated minerals such as hydroxides, hydrated oxides, or hydrated salts of metals, including alumina trihydrate (ATH) or magnesium dihydroxide (MDH).

Magnesium dihydroxide provides excellent flame retardant properties, as well as smoke suppression, in a variety of plastics including wire and cable applications. Magnesium dihydroxide is also a non-toxic, non-corrosive additive, and it is often incorporated into elastomeric and plastic compounds where a non-halogen solution to fire resistance and smoke suppression is preferred.

According to one theory, magnesium dihydroxide, alumina trihydrate, and other metal hydrates function by releasing their water of hydration. In some instances, the temperature of release is above those required for processing but below those of combustion of the flame retardant composition. For example, magnesium dihydroxide undergoes an endothermic decomposition beginning at about 330 degrees Celsius according to:

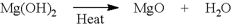

The water released during combustion has the effects of diluting the combustible gases and acting as a barrier to prevent oxygen from supporting the flame. The smoke suppression properties of the metal hydrates are believed to be due to the dilution effect of the water vapor on the combustible gases or due to a char formation with the polymer. At relatively high concentrations, such additives also impair combustion by conducting heat relatively efficiently from burning surfaces. To maximize these flame-retardant effects, the flame retardant additives can be present at maximum levels.

Despite the advantages of certain metal hydrates, their use can be problematic in certain applications. For instance, to obtain very high levels of flame retardant ability (e.g., Underwriters Laboratories' UL 94 rating), flame retardant additives must be added in large amounts, such as greater than 60 weight percent. This concentration of the selected metal hydrate can adversely impact the physical properties, in particular flexibility, and processing characteristics (such as viscosity) of the polymeric resin, thereby rendering the resulting composition unsuitable for certain applications.

There is a need for a low-smoke, non-halogenated flame retardant composition that (a) achieves flame retardancy and (b) does not adversely affect processing or flexibility of the polyolefins at temperatures above about 190 degrees Celsius.

### BRIEF SUMMARY OF THE INVENTION

In a general embodiment, the present disclosure provides a low-smoke, non-halogenated flame retardant composition made from or containing (a) a first ethylene/vinyl acetate copolymer, having a total content of vinyl acetate-derived units in an amount from about 15 to about 45 weight percent, based upon the total weight of the ethylene/vinyl acetate copolymer; (b) a coupling agent; (c) magnesium dihydroxide; (d) hydromagnesite; and (e) huntite.

In some embodiments, the present disclosure provides a low-smoke, non-halogenated flame retardant composition made from or containing (a) about 15 to about 35 weight percent of the first ethylene/vinyl acetate copolymer, based upon the total weight of low-smoke, non-halogenated flame retardant composition; (b) about 5 to about 20 weight percent of the coupling agent, based upon the total weight of low-smoke, non-halogenated flame retardant composition; (c) about 20 to about 40 weight percent of magnesium dihydroxide, based upon the total weight of low-smoke, non-halogenated flame retardant composition; (d) about 10 to about 20 weight percent of hydromagnesite, based upon the total weight of low-smoke, non-halogenated flame retardant composition; and (e) about 10 to about 20 weight percent of huntite, based upon the total weight of low-smoke, non-halogenated flame retardant composition.

In general embodiments, the present disclosure provides a power cable made from or containing (i) a conductor core; (ii) a semiconductive conductor shield; (iii) an insulation layer; (iv) a semiconductive insulation shield; and (v) a jacket made from or containing the low-smoke, non-halogenated flame retardant composition.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### DETAILED DESCRIPTION OF THE INVENTION

The present invention now will be described more fully hereinafter. However, this invention can be embodied in many different forms and should not be construed as limited to the embodiments set forth herein; rather, these embodiments are provided so that this disclosure will satisfy applicable legal requirements. As such, it will be apparent to those skilled in the art that the embodiments can incorporate changes and modifications without departing from the general scope. It is intended to include all the modifications and alterations in so far as the modifications and alterations come within the scope of the appended claims or the equivalents thereof.

As used in this specification and the claims, the singular forms “a,” “an,” and “the” include plural referents unless the context clearly dictates otherwise.

As used in this specification and the claims, the terms “comprising,” “containing,” or “including” mean that at least the named compound, element, material, particle, or method step, etc., is present in the composition, the article, or the method, but does not exclude the presence of other compounds, elements, materials, particles, or method steps, etc., even if the other such compounds, elements, materials, particles, or method steps, etc., have the same function as that which is named, unless expressly excluded in the claims. It is also to be understood that the mention of one or more method steps does not preclude the presence of additional method steps before or after the combined recited steps or intervening method steps between those steps expressly identified.

Moreover, it is also to be understood that the lettering of process steps or ingredients is a means for identifying discrete activities or ingredients and the recited lettering can be arranged in any sequence, unless expressly indicated.

For the purpose of the present description and of the claims which follow, except where otherwise indicated, numbers expressing amounts, quantities, percentages, and so forth, are to be understood as being modified by the term “about”. Also, ranges include any combination of the maximum and minimum points disclosed and include any intermediate ranges therein, which may or may not be specifically enumerated herein.

### Definitions

In the present description, the term “additives composition” refers to a composition made from or containing at least one additive.

In the present description, the term “α-olefin” or “alpha-olefin” means an olefin of formula CH₂═CH—R, wherein R is a linear or branched alkyl containing from 1 to 12 carbon atoms. The α-olefin can be selected, for example, from: propylene, 1-butene, 1-pentene, 1-hexene, 1-octene, 1-dodecene and the like.

In the present description, the term “first” refers to the order in which a particular species is presented and does not necessarily indicate that a “second” species will be presented. For example, “first polymer composition” refers to the first of at least one polymer composition. The term does not reflect priority, importance, or significance in any other way. Similar terms used that can be used herein include “second,” “third,” “fourth,” etc.

In the present description, the term “homopolymer” as used herein is consistent with its ordinary meaning. To the extent that a homopolymer can contain one or more monomeric units, the incorporation of any additional monomeric units has no measurable effect on the polymer's primary, secondary or tertiary structure or no effect on the polymer's physical or chemical properties. In other words, there is no measurable difference between a polymer comprising 100 weight percent of a first monomeric unit, and a co-polymer that includes more than one monomeric units.

In the present description, the term “interpolymer” means a polymer prepared by the polymerization of at least two types of monomers or comonomers. It includes, but is not limited to, copolymers (which can refer to polymers prepared from two different types of monomers or comonomers, although it can be used interchangeably with “interpolymer” to refer to polymers made from three or more different types of monomers or comonomers), terpolymers (which can refer to polymers prepared from three different types of monomers or comonomers), tetrapolymers (which can refer to polymers prepared from four different types of monomers or comonomers), and the like.

In the present description, the terms “monomer” and “comonomer” are used interchangeably. The terms mean any compound with a polymerizable moiety that is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

In the present description, the term “natural magnesium dihydroxide” indicates the magnesium dihydroxide obtained by milling minerals based on magnesium dihydroxide, such as brucite and the like. Brucite can be found in nature in combination with other minerals, such as calcite, aragonite, talc or magnesite, in stratified form between silicate deposits, such as in serpentine, in chlorite, or in schists.

Natural magnesium dihydroxide can contain various impurities deriving from salts, oxides or hydroxides of other metals, such as Fe, Mn, Ca, Si, V, etc. The amount and nature of the impurities present can vary as a function of the origin of the starting material.

In the present description, the term “polymer” means a macromolecular compound prepared by polymerizing monomers of the same or different type. The term “polymer” includes homopolymers, copolymers, terpolymers, interpolymers, and so on.

In the present description, the term “polymer composition” refers to a composition made from or containing at least one polymer.

In the present description, the term “polyolefin” is used herein broadly to include polymers such as polyethylene, ethylene-alpha olefin copolymers (EAO), polypropylene, polybutene, and ethylene copolymers having at least about 50 percent by weight of ethylene polymerized with a lesser amount of a comonomer such as vinyl acetate, and other polymeric resins within the “olefin” family classification.

Polyolefins can be made by a variety of processes including batch and continuous processes using single, staged, or sequential reactors, slurry, solution, and fluidized bed processes and one or more catalysts including for example, heterogeneous and homogeneous systems and Ziegler, Phillips, metallocene, single-site, and constrained geometry catalysts to produce polymers having different combinations of properties.

Testing

ASTM D 638 is entitled “Standard Test Method for Tensile Properties of Plastics.” The term “ASTM D 638” as used herein refers to the test method designed to produce tensile property data for the control and specification of plastic materials. Examples of tensile properties measured include tensile strength and elongation at break. This test method covers the determination of the tensile properties of unreinforced and reinforced plastics in the form of standard dumbbell-shaped test specimens when tested under defined conditions of pretreatment, temperature, humidity, and testing machine speed. This test method can be used for testing materials of any thickness up to 14 mm (0.55 in.). This test method was approved in 2010, the contents of which are incorporated herein by reference in its entirety.

ASTM D 792 is entitled “Test Methods for Density and Specific Gravity (Relative Density) of Plastics by Displacement.” The term “ASTM D 792” as used herein refers to the standard test method for determining the specific gravity (relative density) and density of solid plastics in forms such as sheets, rods, tubes, or molded items. The test method includes determining the mass of a specimen of the solid plastic in air, determining the apparent mass of the specimen upon immersion in a liquid, and calculating the specimen's specific gravity (relative density). This test method was approved on Jun. 15, 2008 and published July 2008, the contents of which are incorporated herein by reference in its entirety.

ASTM D 1238 is entitled “Test Method for Melt Flow Rates of Thermoplastics by Extrusion Plastometer.” The term “ASTM D 1238” as used herein refers to a test method covering the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on Feb. 1, 2012 and published March 2012, the contents of which are incorporated herein by reference in its entirety.

Throughout the present description and claims, the standard melt index values of polyethylene polymers are measured according to ASTM D 1238, using a piston load of 2.16 kg and at a temperature of 190 degrees Celsius. The High Load Melt Index (or HLMI) values are also measured according to ASTM D 1238, but using a piston load of 21.6 kg and at a temperature of 190 degrees Celsius.

For the referenced ASTM standards, visit the ASTM website, www.astm.org, or contact ASTM Customer Service at service@astm.org.

The term “UL 44/UL 2556” as used herein refers to the standard detailing the performance requirements and test methods for thermoset-insulated wire and cables. The UL 44 standard refers the reader to UL 2556 for the specific wire and cable test methods. In general, these test standards cover the requirements and methods for determination of electrical, mechanical, and flame characteristics testing. UL 44 (published Sep. 10, 2010) and UL 2556 (published on Mar. 22, 2013) are incorporated herein by reference in their entirety.

The term “UL 1685” as used herein refers to the standard entitled “Vertical-Tray Fire-Propagation and Smoke-Release Test for Electrical and Optical-Fiber Cables” and details the smoke measurement component. For a cable to be acceptable under the UL test procedure, each of the following is to be exhibited: (a) the cable char height is to be less than 8 ft, 0 inch (244 cm) when measured from the bottom of the cable tray; (b) the total smoke released is to be 95 m² or less; and (c) the peak smoke release rate is to be 0.25 m²/s or less. UL 1685 (published Apr. 25, 2007) is incorporated herein by reference in its entirety.

For the referenced UL standards, visit the IHS website, http://www.global.ihs.com or contact IHS Customer Service via email at global@ihs.com.

In a general embodiment, the present disclosure provides a low-smoke, non-halogenated flame retardant composition made from or containing (a) a first ethylene/vinyl acetate copolymer, having a total content of vinyl acetate-derived units in an amount from about 15 to about 45 weight percent, based upon the total weight of the ethylene/vinyl acetate copolymer; (b) a coupling agent; (c) magnesium dihydroxide; (d) hydromagnesite; and (e) huntite.

First Ethylene/Vinyl Acetate Copolymer

The first ethylene/vinyl acetate copolymer has a total content of vinyl acetate-derived units in an amount from about 15 to about 45 weight percent, based upon the total weight of the ethylene/vinyl acetate copolymer. In some embodiments, the total content of vinyl acetate-derived units in an amount from about 20 to about 35 weight percent. In some embodiments, the total content of vinyl acetate-derived units is present in 20, 21, 22, 23, 24, 25, 26, 27, 28, 29, 30, 31, 32, 33, 34, and 35 weight percent, based upon the total weight of the ethylene/vinyl acetate copolymer.

In some embodiments, the first ethylene/vinyl acetate copolymer is present in an amount from about 15 to about 35 weight percent, based upon the total weight of low-smoke, non-halogenated flame retardant composition. In some embodiments, the first ethylene/vinyl acetate copolymer is present in an amount from about 20 to about 30 weight percent. In some embodiments, the first ethylene/vinyl acetate copolymer is present in 20, 21, 22, 23, 24, 25, 26, 27, 28, 29, and 30 weight percent, based upon the total weight of low-smoke, non-halogenated flame retardant composition.

In some embodiments, the first ethylene/vinyl acetate copolymers include ATEVA™ 2821A ethylene/vinyl acetate copolymer having a content of vinyl acetate-derived units in an amount of 28 weight percent, based upon the total weight of the ethylene/vinyl acetate copolymer, a melt index of 25 grams per 10 minutes (190° C./2.16 kg, ASTM D1238), and a density of 0.946 g/cm³ and ATEVA™ 2861A ethylene/vinyl acetate copolymer having a content of vinyl acetate-derived units in an amount of 28 weight percent, based upon the total weight of the ethylene/vinyl acetate copolymer, a melt index of 6.0 grams per 10 minutes (190° C./2.16 kg, ASTM D1238), and a density of 0.949 g/cm³. Both are commercially available from Celanese Corporation.

Coupling Agent

In some embodiments, the coupling agent is present in an amount from about 5 to about 20 weight percent of the coupling agent, based upon the total weight of the low-smoke, non-halogenated flame retardant composition. In some embodiments, the coupling agent is present in an amount from about 5 to about 15 weight percent. In some embodiments, the coupling agent is present in 5, 6, 7, 8, 9, 10, 11, 12, 13, 14, and 15 weight percent, based upon the total weight of low-smoke, non-halogenated flame retardant composition.

In some embodiments, the coupling agent is a polyolefin grafted with an unsaturated monomer.

In some embodiments, the polyolefin is a polyethylene. In some embodiments, the polyethylene is a metallocene-catalyzed linear low density polyethylene.

In some embodiments, the unsaturated monomer is an unsaturated polar monomer and containing one or more oxygen atoms. In some embodiments, the unsaturated monomers is selected from the group consisting of ethylenically unsaturated carboxylic acids and acid derivatives. In some embodiments, the ethylenically unsaturated carboxylic acids and acid derivatives is selected from group consisting of esters, anhydrides, and acid salts. In some embodiments, the unsaturated monomers is selected from the group consisting of acrylic acid, methacrylic acid, maleic acid, fumaric acid, itaconic acid, citraconic acid, maleic anhydride, tetrahydrophthalic anhydride, norborn-5-ene-2,3-dicarboxylic acid anhydride, nadic anhydride, himic anhydride, and mixtures thereof. In some embodiments, the unsaturated monomer is maleic anhydride.

The unsaturated monomer can be used in an amount within the range of about 0.1 to about 10 weight percent, based on the total weight of the grafted polyolefin grafted. In other embodiments, the unsaturated monomer can be in the range of from about 0.1 to about 6 weight percent. In some embodiments, the range can be from about 0.2 to about 1.0 weight percent.

In some embodiments, the polyolefin grafted with an unsaturated monomer is a metallocene-catalyzed linear low density polyethylene grafted with maleic anhydride. In some embodiments, the grafted metallocene-catalyzed linear low density polyethylene has a melt index from about 0.5 to about 20 grams per 10 minutes, a density from about 0.840 to about 0.920 grams per cubic centimeter, and the unsaturated monomer in an amount within the range of about 0.2 to about 1.0 weight percent, based on the total weight of the grafted polyolefin.

In some embodiments, the grafted polyolefins include TAFMER™ MA8510 maleic anhydride-grafted polyethylene having a melt index of 2.4 grams per 10 minutes (190° C./2.16 kg, ASTM D1238) and a density of 0.885 g/cm³ and TAFMER™ MA9015 maleic anhydride-grafted polyethylene having a melt index of 11 grams per 10 minutes (190° C./2.16 kg, ASTM D1238) and a density of 0.896 g/cm³. Both are commercially available from Mitsui Chemicals.

Magnesium Dihydroxide

In some embodiments, magnesium dihydroxide is present in an amount from about 20 to about 40 weight percent, based upon the total weight of low-smoke, non-halogenated flame retardant composition. In some embodiments, magnesium dihydroxide is present in an amount from about 25 to about 35 weight percent. In some embodiments, magnesium dihydroxide is present in 25, 26, 27, 28, 29, 30, 31, 32, 33, 34, and 35 weight percent, based upon the total weight of low-smoke, non-halogenated flame retardant composition.

The magnesium dihydroxide composition can be made using wet or dry milling methods and equipment. In some embodiments, the wet grinding mill for particle size reduction includes an enclosed vessel filled with small spheres or beads referred to as grinding media, which are activated by an agitator shaft that creates shearing and impacting forces. The rotation of the agitator imparts energy to the surrounding media, and the forces generated act on a slurry of particles continuously pumped through the grinding chamber. The force applied to the particles in the slurry serve to tear apart or crush the particles. The grinding media is retained inside the mill during the process. The primary process parameters are solids content of the slurry, agitator speed, product flow rate, and type and size of grinding media. Types of grinding mills include horizontal disk mills, high-energy pin mills, and the like.

In some embodiments, the magnesium dihydroxide is produced synthetically via brine or seawater precipitation, the Aman process, or the Magnifin process. The brine or seawater precipitation process utilizes calcium hydroxide (Ca(OH)₂) derived from lime (CaO) or dolime (CaO—MgO) to precipitate out magnesium dihydroxide from magnesium chloride (MgCl₂) present in the brine or seawater. The Aman process hydropyrolyzes MgCl₂ brine solution into magnesium oxide which is later converted into magnesium dihydroxide via a hydration process. The Magnifin process coverts serpentinite ore (Mg₃[Si₂O₅](OH)₄ into magnesium dihydroxide via a three-step process involving hydrochloric acid leaching, hydropyrolysis, and hydration.

In some embodiments, the magnesium dihydroxide particles is coated with a surface active agent. In some embodiments, the coating is an anionic surfactant. In some embodiments, fatty acids and metal salts or esters thereof are surface active coating agents. In some embodiments, the fatty acids and derivatives thereof have 10 or more carbon atoms. In some embodiments, the surface active agents include stearic acid, oleic acid, erucic acid, lauric acid, behenic acid, palmitic acid and alkali metal salts thereof, ammonium stearate, sodium dilauryl benzenesulfonate, potassium octadecylfsulfate, sodium laurylsulfonate, and disodium 2-sulfoethyl-α-sulfostearate.

In some embodiments, the surface active coating agents include (i) silane coupling agents such as vinylethoxysilane, vinyl-tris(2-methoxy)silane, γ-methacryloxypropyltrimethoxysilane, γ-aminopropyltrimethoxysilane, (3-(3,4-epoxycyclohexyl)ethyltrimethoxysilane, γ-glycidoxypropyltrimethoxysilane and γ-mercaptopropyltrimethoxysilane; (ii) titanate-containing coupling agents such as isopropyltriisostearoyl titanate, isopropyltris(dioctylpyrophosphate), isopropyltri(N-aminoethyl-aminoethyl)titanate and isopropyltridecylbezenesulfonyl titanate; (iii) aluminum-containing coupling agents such as acetoalkoxyaluminum diisopropylate; (iv) phosphate esters such as mono- or diester of orthophosphoric acid and stearyl alcohol, a mixture of these esters or alkali metal salt of these esters or amine salt of these esters, and (v) anionic surfactants such as amide-bonding aliphatic carboxylate, amide-bonding sulfate, amide-bonding sulfonate, amide-bonding alkylallylsulfonate, sulfates of a higher alcohol such as stearyl alcohol, sulfates of polyethylene glycol ether, ester-bonding sulfates, ester-bonding sulfonates, ester-bonding alkylallylsulfonates, and ether-bonding alkylallylsulfonates. In some embodiments, the surface active coating agents is used singly or as a mixture of two or more.

In some embodiments, magnesium dihydroxide is 5B-1G™ magnesium hydroxide having a Specific Surface Area of 6 m²/g and a Specific Gravity of 2.39, which is commercially available from Kisuma Chemicals BV.

Hydromagnesite

In some embodiments, hydromagnesite is present in an amount from about 10 to about 20 weight percent of the coupling agent, based upon the total weight of the low-smoke, non-halogenated flame retardant composition. In some embodiments, hydromagnesite is present in 10, 11, 12, 13, 14, 15, 16, 17, 18, 19, and 20 weight percent, based upon the total weight of low-smoke, non-halogenated flame retardant composition.

Hydromagnesite is a hydrated magnesium carbonate mineral, having the formula Mg₅(CO₃)₄(OH)₂.4H₂O.

Huntite

In some embodiments, huntite is present in an amount from about 10 to about 20 weight percent of the coupling agent, based upon the total weight of the low-smoke, non-halogenated flame retardant composition. In some embodiments, huntite is present in 10, 11, 12, 13, 14, 15, 16, 17, 18, 19, and 20 weight percent, based upon the total weight of low-smoke, non-halogenated flame retardant composition.

Huntite is a carbonate mineral, having the formula Mg₃Ca(CO₃)₄.

In some embodiments, hydromagnesite and huntite are provided as a mixture. In some embodiments, the mixture is ULTRACARB™ hydromagnesite huntite, having a Specific Gravity of 2.4, a Surface Area of about 11 to about 17 m²/g, and a Loose Bulk Density of 0.4 kg/l, commercially available from LKAB Minerals AB. In some embodiments, the mixture includes ULTRACARB™ LH3 primary hydromagnesite.

In some embodiments, the low-smoke, non-halogenated flame retardant composition has a HLMI value of about 0.5 to about 15 g/10 minutes, alternatively about 1.2 to about 13 g/10 minutes, alternatively about 5 to about 10 g/10 minutes.

In some embodiments, the low-smoke, non-halogenated flame retardant composition has a tensile strength of about 1000 to about 2100 psi, alternatively about 1150 to about 2050 psi, alternatively about 1450 to about 2000 psi.

In some embodiments, the low-smoke, non-halogenated flame retardant composition has an elongation at break of about 50 to about 250%, alternatively about 100 to about 225%, alternatively about 150 to about 220%.

Second Ethylene/Vinyl Acetate Copolymer

In some embodiments, the low-smoke, non-halogenated flame retardant composition is further made from or containing (a2) a second ethylene/vinyl acetate copolymer, having a total content of vinyl acetate-derived units in an amount from about 15 to about 25 weight percent, based upon the total weight of the ethylene/vinyl acetate copolymer and a melt index from about 1.0 to about 3.0 grams per 10 minutes measured according to ASTM D 1238, using a piston load of 2.16 kg and at a temperature of 190 degrees Celsius. In some embodiments, the total content of vinyl acetate-derived units in an amount from about 15 to about 20 weight percent. In some embodiments, the total content of vinyl acetate-derived units is present in 15, 16, 17, 18, 19, and 20 weight percent, based upon the total weight of the ethylene/vinyl acetate copolymer.

In some embodiments, the second ethylene/vinyl acetate copolymer is present in an amount from about 0 to about 10 weight percent, based upon the total weight of low-smoke, non-halogenated flame retardant composition. In some embodiments, the second ethylene/vinyl acetate copolymer is present in an amount from about 0.5 to about 10 weight percent. In some embodiments, the second ethylene/vinyl acetate copolymer is present in 0.5, 1, 2, 3, 4, 5, 6, 7, 8, 9, and 10 weight percent, based upon the total weight of low-smoke, non-halogenated flame retardant composition.

In some embodiments, the second ethylene/vinyl acetate copolymers include ULTRATHENE™ UE624000 ethylene/vinyl acetate copolymer having a content of vinyl acetate-derived units in an amount of 18 weight percent, based upon the total weight of the ethylene/vinyl acetate copolymer, and a melt index of 2.1 grams per 10 minutes (190° C./2.16 kg, ASTM D1238), and a density of 0.946 g/cm³, which is commercially available from LyondellBasell.

Additives

In some embodiments, the low-smoke, non-halogenated flame retardant composition is further made from or containing (f) an additives composition. In some embodiments, the additives are selected from the group consisting of colorants, odorants, deodorants, plasticizers, impact modifiers, fillers, nucleating agents, lubricants, surfactants, wetting agents, flame retardants, ultraviolet light stabilizers, antioxidants, biocides, metal deactivating agents, thickening agents, heat stabilizers, defoaming agents, other coupling agents, polymer alloy compatibilizing agent, blowing agents, emulsifiers, crosslinking agents, waxes, particulates, flow promoters, and other materials added to enhance processability or end-use properties of the polymeric components.

In some embodiments, the additives composition is present in an amount from about 0 to about 15 weight percent, based upon the total weight of low-smoke, non-halogenated flame retardant composition. In some embodiments, the additives composition is present in an amount from about 0.5 to about 15 weight percent. In some embodiments, the additives composition is present in an amount from about 3 to about 8 weight percent. In some embodiments, the additives composition is present in 3, 4, 5, 6, 7, and 8 weight percent, based upon the total weight of low-smoke, non-halogenated flame retardant composition.

In some embodiments, the additives composition is made from or contains an antioxidant selected from the group consisting a benzimidazole antioxidant, a sterically-hindered phenolic antioxidant and a thioester antioxidant. In some embodiments, the antioxidant is present in an amount from about 0.1 to about 0.5 weight percent, based upon the total weight of low-smoke, non-halogenated flame retardant composition. In some embodiments, the antioxidant is present in 0.1, 0.2, 0.3, 0.4, and 0.5 weight percent, based upon the total weight of low-smoke, non-halogenated flame retardant composition.

In some embodiments, the antioxidant is a benzimidazole antioxidant. In some embodiments, the benzimidazole antioxidant is VANOX™ zinc 2-mercaptotolumidazole, which is commercially available from Vanderbilt Chemicals, LLC.

In some embodiments, the antioxidant is a sterically-hindered phenolic antioxidant. In some embodiments, the sterically-hindered phenolic antioxidant is IRGANOX™ 1010 pentaerythritol tetrakis(3-(3,5-di-tert-butyl-4-hydroxyphenyl)propionate), which is commercially available from BASF.

In some embodiments, the antioxidant is a thioester antioxidant. In some embodiments, the thioester antioxidant is NAUGARD™ 412S pentaerythritol tetrakis (β-laurylthiopropionate), which is commercially available from Addivant Corporation.

In some embodiments, the additives composition is made from or contains an lauric acid. In some embodiments, the lauric acid is present in an amount from about 0.05 to about 0.5 weight percent, based upon the total weight of low-smoke, non-halogenated flame retardant composition. In some embodiments, the lauric acid is present in 0.05, 0.1, 0.2, 0.3, 0.4, and 0.5 weight percent, based upon the total weight of low-smoke, non-halogenated flame retardant composition.

In some embodiments, the additives composition is made from or contains a wax. In some embodiments, the wax is present in an amount from about 0.05 to about 0.5 weight percent, based upon the total weight of low-smoke, non-halogenated flame retardant composition. In some embodiments, the wax is present in 0.05, 0.1, 0.2, 0.3, 0.4, and 0.5 weight percent, based upon the total weight of low-smoke, non-halogenated flame retardant composition. In some embodiments, the wax is an ethylene bis-stearamide wax.

In some embodiments, the additives composition is made from or contains silicon pellets. In some embodiments, the silicon pellets are present in an amount from about 1.0 to about 4.0 weight percent, based upon the total weight of low-smoke, non-halogenated flame retardant composition. In some embodiments, the silicon pellets are present in 1.0, 2.0, 3.0, and 4.0 weight percent, based upon the total weight of low-smoke, non-halogenated flame retardant composition. In some embodiments, the silicon pellets are GENIOPLAST™ Pellet S silicone gum formulation pellets, which are commercially available from Wacker Chemie AG.

In some embodiments, the additives composition is made from or contains a clay. In some embodiments, the clay is present in an amount from about 1 to about 8 weight percent, based upon the total weight of low-smoke, non-halogenated flame retardant composition. In some embodiments, the clay is present in 1, 2, 3, 4, 5, 6, 7, and 8 weight percent, based upon the total weight of low-smoke, non-halogenated flame retardant composition. In some embodiments, the clay is a quaternary ammonium-surface-treated nanoclay. In some embodiments, the quaternary ammonium-surface-treated nanoclay is NANOMER™ 1.44P nanoclay, which is commercially available from Nanocor, Inc.

In some embodiments, the present disclosure provides a low-smoke, non-halogenated flame retardant composition made from or containing (a) about 15 to about 35 weight percent, based upon the total weight of the low-smoke, non-halogenated flame retardant composition, of a first ethylene/vinyl acetate copolymer, having a total content of vinyl acetate-derived units in an amount from about 15 to about 45 weight percent, based upon the total weight of the ethylene/vinyl acetate copolymer; (b) about 5 to about 20 weight percent of a coupling agent, based upon the total weight of the low-smoke, non-halogenated flame retardant composition; (c) about 20 to about 40 weight percent of magnesium dihydroxide, based upon the total weight of the low-smoke, non-halogenated flame retardant composition; (d) about 10 to about 20 weight percent of hydromagnesite, based upon the total weight of the low-smoke, non-halogenated flame retardant composition; and (e) about 10 to about 20 weight percent of huntite, based upon the total weight of the low-smoke, non-halogenated flame retardant composition.

In some embodiments, the present disclosure provides a low-smoke, non-halogenated flame retardant composition made from or containing (a) about 15 to about 35 weight percent of the first ethylene/vinyl acetate copolymer, based upon the total weight of the low-smoke, non-halogenated flame retardant composition; (a2) about 0 to about 10 weight percent of a second ethylene/vinyl acetate copolymer, based upon the total weight of the low-smoke, non-halogenated flame retardant composition, wherein the second ethylene/vinyl acetate copolymer has a total content of vinyl acetate-derived units in an amount from about 15 to about 25 weight percent, based upon the total weight of the ethylene/vinyl acetate copolymer and a melt index from about 1.0 to about 3.0 grams per 10 minutes measured according to ASTM D 1238, using a piston load of 2.16 kg and at a temperature of 190 degrees Celsius; (b) about 5 to about 20 weight percent of the coupling agent, based upon the total weight of the low-smoke, non-halogenated flame retardant composition; (c) about 20 to about 40 weight percent of magnesium dihydroxide, based upon the total weight of the low-smoke, non-halogenated flame retardant composition; (d) about 10 to about 20 weight percent of hydromagnesite, based upon the total weight of the low-smoke, non-halogenated flame retardant composition; (e) about 10 to about 20 weight percent of huntite, based upon the total weight of the low-smoke, non-halogenated flame retardant composition; and (f) about 0 to about 15 weight percent of an additives composition, based upon the total weight of the low-smoke, non-halogenated flame retardant composition. In an embodiment, the composition has about the same weight percent of huntite as hydromagnesite. Alternatively the weight percent of huntite in the composition is within 5-10 percent (alternatively within 5 percent) of the weight percent of hydromagnesite in the composition. In an embodiment, the composition has the same mass percent of huntite as hydromagnesite, which may range from about 10 to about 20 mass percent. Alternatively the mass percent of huntite in the composition is within 5-10 percent (alternatively within 5 percent) of the mass percent of hydromagnesite in the composition.

In some embodiments, the present disclosure provides a low-smoke, non-halogenated flame retardant composition made from or containing (a) about 15 to about 25 weight percent, based upon the total weight of the low-smoke, non-halogenated flame retardant composition, of an ethylene/vinyl acetate copolymer, having a total content of vinyl acetate-derived units in an amount from about 25 to about 30 weight percent, based upon the total weight of the ethylene/vinyl acetate copolymer; (b) about 8 to about 12 weight percent of a coupling agent, based upon the total weight of the low-smoke, non-halogenated flame retardant composition; (c) about 20 to about 40 weight percent of magnesium dihydroxide, based upon the total weight of the low-smoke, non-halogenated flame retardant composition; (d) about 10 to about 20 weight percent of hydromagnesite, based upon the total weight of the low-smoke, non-halogenated flame retardant composition; and (e) about 10 to about 20 weight percent of huntite, based upon the total weight of the low-smoke, non-halogenated flame retardant composition.

In general embodiments, the present disclosure provides a power cable made from or containing (i) a conductor core; (ii) a semiconductive conductor shield; (iii) an insulation layer; (iv) a semiconductive insulation shield; and (v) a jacket made from or containing the low-smoke, non-halogenated flame retardant composition.

### Examples

The following examples are included to demonstrate embodiments. It should be appreciated by those of skill in the art that the techniques disclosed in the examples which follow represent techniques discovered to function well, and thus can be considered to constitute exemplary modes of practice. However, those of skill in the art should, in light of the present disclosure, appreciate that many changes can be made in the specific embodiments which are disclosed and still obtain a like or similar result without departing from the spirit and scope of this disclosure.

For the comparative examples and the examples of an embodiment, various compounds were formulated to prepare test specimen. The materials were admixed in the weight percents shown in Table 1 and Table 2. The first ethylene/vinyl acetate copolymer and the coupling agent were evaluated in more than one form. The specific description of the various form is provided in footnotes to the Table. Additionally, comparative examples bear the designation C.E. while examples of an embodiment bear the designation Ex. The HLMI values were measured according to ASTM D 1238, using a piston load of 21.6 kg and at a temperature of 190 degrees Celsius. The tensile strength and elongation at break values were measured according to ASTM D 638.

The second ethylene/vinyl acetate copolymer, when present, was ULTRATHENE™ UE624000 ethylene/vinyl acetate copolymer having a content of vinyl acetate-derived units in an amount of 18 weight percent, based upon the total weight of the ethylene/vinyl acetate copolymer, and a melt index of 2.1 grams per 10 minutes (190° C./2.16 kg, ASTM D1238), and a density of 0.946 g/cm³, which is commercially available from LyondellBasell.

The magnesium dihydroxide (MDH) was 5B-1G™ magnesium hydroxide having a Specific Surface Area of 6 m²/g and a Specific Gravity of 2.39, which was commercially available from Kisuma Chemicals BV.

The hydromagnesite and the huntite were provided as a mixture in ULTRACARB™ hydromagnesite huntite (HMH), having a Specific Gravity of 2.4, a Surface Area of about 11 to about 17 m²/g, and a Loose Bulk Density of 0.4 kg/l, which was commercially available from LKAB Minerals AB.

The aluminum trihydroxide (ATH) was HYDRAL™ PGA aluminum trihydroxide, which was commercially available from J.M. Huber Corporation.

The benzimidazole antioxidant was VANOX™ zinc 2-mercaptotolumidazole (ZMTI), which was commercially available from Vanderbilt Chemicals, LLC. In all Table 1 compositions, ZMTI was added in 0.3 weight percent, based upon the total weight of the composition. In all Table 2 compositions, ZMTI was added in 0.15 weight percent, based upon the total weight of the composition.

The sterically-hindered phenolic antioxidant was IRGANOX™ 1010 pentaerythritol tetrakis(3-(3,5-di-tert-butyl-4-hydroxyphenyl)propionate), which was commercially available from BASF. In all Table 1 compositions, IRGANOX™ 1010 was added in 0.4 weight percent, based upon the total weight of the composition. In all Table 2 compositions, IRGANOX™ 1010 was added in 0.3 weight percent, based upon the total weight of the composition.

The thioester antioxidant was NAUGARD™ 412S pentaerythritol tetrakis (β-laurylthiopropionate), which was commercially available from Addivant Corporation. In all compositions (for both Table 1 and Table 2), NAUGARD™ 412S was added in 0.1 weight percent, based upon the total weight of the composition.

The silicon pellets were GENIOPLAST™ Pellet S silicone gum formulation pellets (Pellet S), which were commercially available from Wacker Chemie AG. In all Table 2 compositions, Pellet S was added in 2.0 weight percent, based upon the total weight of the composition.

The quaternary ammonium-surface-treated nanoclay was NANOMER™ 1.44P nanoclay, which was commercially available from Nanocor, Inc. In all Table 1 compositions, NANOMER™ 1.44P was added in 5.0 weight percent, based upon the total weight of the composition. In all Table 2 compositions, NANOMER™ 1.44P was added in 3.0 weight percent, based upon the total weight of the composition.

In all compositions, lauric acid was added in 0.1 weight percent, based upon the total weight of the composition.

In all Table 2 compositions, ethylene bis-stearamide wax was added in 0.5 weight percent, based upon the total weight of the composition.

TABLE 1

| Component | C.E. 1 | C.E. 2 | C.E. 3 | Ex. 4 | Ex. 5 | Ex. 6 | Ex. 7 | Ex. 8 |
|---|---|---|---|---|---|---|---|---|
| First EVA¹ | 20.1 | 20.1 | 20.1 | 20.1 | 18.1 | 25.1 | 22.1 | 20.1 |
| Second EVA | 7 | 7 | 7 | 7 | 7 | | | |
| Coupling Agent² | 5 | 5 | 5 | 5 | 7 | 7 | 10 | 10 |
| Magnesium | 62 | | | 31 | 31 | 31 | 31 | 32 |
| Dihydroxide | | | | | | | | |
| HMH | | 62 | | 31 | 31 | 31 | 31 | 32 |
| ATH | | | 62 | | | | | |

Physical Properties

| | | | | | | | | |
|---|---|---|---|---|---|---|---|---|
| HLMI (g/10 minutes) | 6.1 | 3.2 | 3.5 | 5.6 | 1.8 | 3.4 | 1.2 | 0.6 |
| Tensile Strength, psi | 2067 | 1520 | 1634 | 1948 | 1980 | 1936 | 2002 | 1935 |
| Elongation at Break, % | 152 | 105 | 120 | 184 | 192 | 200 | 180 | 157 |

¹First EVA was ATEVA ™ 2861A ethylene/vinyl acetate copolymer having a content of vinyl acetate-derived units in an amount of 28 weight percent, based upon the total weight of the ethylene/vinyl acetate copolymer, a melt index of 6.0 grams per 10 minutes (190° C./2.16 kg, ASTM D1238), and a density of 0.949 g/cm³, which was commercially available from Celanese Corporation.
²Coupling Agent was TAFMER ™ MA8510 maleic anhydride-grafted polyethylene having a melt index of 2.4 grams per 10 minutes (190° C./2.16 kg, ASTM D1238) and a density of 0.885 g/cm³, which was commercially available from Mitsui Chemicals.

TABLE 2

| Component | Ex. 9 | Ex. 10 | Ex. 11 | Ex. 12 | Ex. 13 | Ex. 14 | Ex. 15 |
|---|---|---|---|---|---|---|---|
| First EVA¹ | 26.85 | 28.45 | | | 25.15 | 21.85 | 16.85 |
| First EVA² | | | 26.85 | 24.85 | | | |
| Coupling Agent³ | 5 | | 5 | 7 | | 10 | 15 |
| Coupling Agent⁴ | | 3.4 | | | 6.7 | | |
| Magnesium Dihydroxide | 31 | 31 | 31 | 31 | 31 | 31 | 31 |
| HMH | 31 | 31 | 31 | 31 | 31 | 31 | 31 |

Physical Properties

| | | | | | | | |
|---|---|---|---|---|---|---|---|
| HLMI (g/10 minutes) | 11.5 | 9.4 | 12.6 | 7.2 | 6.7 | 10.0 | 5.0 |
| Tensile Strength, psi | 1280 | 1229 | 1075 | 1185 | 1470 | 1730 | 1920 |
| Elongation at Break, % | 155 | 83 | 72 | 84 | 150 | 220 | 154 |

¹First EVA was ATEVA ™ 2861A ethylene/vinyl acetate copolymer having a content of vinyl acetate-derived units in an amount of 28 weight percent, based upon the total weight of the ethylene/vinyl acetate copolymer, a melt index of 6.0 grams per 10 minutes (190° C./2.16 kg, ASTM D1238), and a density of 0.949 g/cm³, which was commercially available from Celanese Corporation.
²First EVA was ATEVA ™ 2821A ethylene/vinyl acetate copolymer having a content of vinyl acetate-derived units in an amount of 28 weight percent, based upon the total weight of the ethylene/vinyl acetate copolymer, a melt index of 25 grams per 10 minutes (190° C./2.16 kg, ASTM D1238), and a density of 0.946 g/cm³, which was commercially available from Celanese Corporation.
³Coupling Agent was TAFMER ™ MA8510 maleic anhydride-grafted polyethylene having a melt index of 2.4 grams per 10 minutes (190° C./2.16 kg, ASTM D1238) and a density of 0.885 g/cm³, which was commercially available from Mitsui Chemicals.
⁴Coupling Agent was TAFMER ™ MA9015 maleic anhydride-grafted polyethylene having a melt index of 11 grams per 10 minutes (190° C./2.16 kg, ASTM D1238) and a density of 0.896 g/cm³, which was commercially available from Mitsui Chemicals.

It should be understood that various changes, substitutions and alterations can be made herein without departing from the spirit and scope of this disclosure as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

What is claimed is:

1. A low-smoke, non-halogenated flame retardant composition comprising:
(A) a first ethylene/vinyl acetate copolymer, having a total content of vinyl acetate-derived units in an amount from about 15 to about 45 weight percent, based upon the total weight of the ethylene/vinyl acetate copolymer;
(B) a coupling agent;
(C) magnesium dihydroxide;
(D) hydromagnesite; and
(E) huntite.

2. The low-smoke, non-halogenated flame retardant composition of claim 1, comprising:
(A) about 15 to about 35 weight percent of the first ethylene/vinyl acetate copolymer, based upon the total weight of the low-smoke, non-halogenated flame retardant composition;
(B) about 5 to about 20 weight percent of the coupling agent, based upon the total weight of the low-smoke, non-halogenated flame retardant composition;
(C) about 20 to about 40 weight percent of magnesium dihydroxide, based upon the total weight of the low-smoke, non-halogenated flame retardant composition;
(D) about 10 to about 20 weight percent of hydromagnesite, based upon the total weight of the low-smoke, non-halogenated flame retardant composition; and
(E) about 10 to about 20 weight percent of huntite, based upon the total weight of the low-smoke, non-halogenated flame retardant composition.

3. The low-smoke, non-halogenated flame retardant composition of claim 1, wherein the coupling agent is a polyolefin grafted with an unsaturated monomer.

4. The low-smoke, non-halogenated flame retardant composition of claim 3, wherein the polyolefin grafted with an unsaturated monomer is a metallocene-catalyzed linear low density polyethylene grafted with maleic anhydride.

5. The low-smoke, non-halogenated flame retardant composition of claim 4, wherein the maleic anhydride-grafted polyethylene has a melt index from about 0.5 to about 20 grams per 10 minutes, a density from about 0.840 to about 0.920 grams per cubic centimeter, and the unsaturated monomer from about 0.2 to about 1.0 weight percent, based on the total weight of the maleic anhydride-grafted polyethylene.

6. The low-smoke, non-halogenated flame retardant composition of claim 1, further comprising:
(A2) a second ethylene/vinyl acetate copolymer, having a total content of vinyl acetate-derived units in an amount from about 15 to about 25 weight percent, based upon the total weight of the ethylene/vinyl acetate copolymer and a melt index from about 1.0 to about 3.0 grams per 10 minutes measured according to ASTM D 1238, using a piston load of 2.16 kg and at a temperature of 190 degrees Celsius.

7. The low-smoke, non-halogenated flame retardant composition of claim 1, further comprising:
(F) an additives composition.

8. The low-smoke, non-halogenated flame retardant composition of claim 1, comprising:
(A) about 15 to about 35 weight percent of the first ethylene/vinyl acetate copolymer, based upon the total weight of the low-smoke, non-halogenated flame retardant composition;
(A2) about 0 to about 10 weight percent of a second ethylene/vinyl acetate copolymer, based upon the total weight of the low-smoke, non-halogenated flame retardant composition, wherein the second ethylene/vinyl acetate copolymer has a total content of vinyl acetate-derived units in an amount from about 15 to about 25 weight percent, based upon the total weight of the ethylene/vinyl acetate copolymer and a melt index from about 1.0 to about 3.0 grams per 10 minutes measured according to ASTM D 1238, using a piston load of 2.16 kg and at a temperature of 190 degrees Celsius;
(B) about 5 to about 20 weight percent of the coupling agent, based upon the total weight of the low-smoke, non-halogenated flame retardant composition;
(C) about 20 to about 40 weight percent of magnesium dihydroxide, based upon the total weight of the low-smoke, non-halogenated flame retardant composition;
(D) about 10 to about 20 weight percent of hydromagnesite, based upon the total weight of the low-smoke, non-halogenated flame retardant composition;
(E) about 10 to about 20 weight percent of huntite, based upon the total weight of the low-smoke, non-halogenated flame retardant composition; and
(F) about 0 to about 15 weight percent of an additives composition, based upon the total weight of the low-smoke, non-halogenated flame retardant composition.

9. A low-smoke, non-halogenated flame retardant composition comprising:
(A) about 15 to about 25 weight percent, based upon the total weight of the low-smoke, non-halogenated flame retardant composition, of an ethylene/vinyl acetate copolymer having a total content of vinyl acetate-derived units in an amount from about 25 to about 30 weight percent, based upon the total weight of the ethylene/vinyl acetate copolymer;
(B) about 8 to about 12 weight percent of the coupling agent, based upon the total weight of the low-smoke, non-halogenated flame retardant composition;
(C) about 20 to about 40 weight percent of magnesium dihydroxide, based upon the total weight of the low-smoke, non-halogenated flame retardant composition;
(D) about 10 to about 20 weight percent of hydromagnesite, based upon the total weight of the low-smoke, non-halogenated flame retardant composition; and
(E) about 10 to about 20 weight percent of huntite, based upon the total weight of the low-smoke, non-halogenated flame retardant composition.

10. A power cable comprising:
(A) a conductor core;
(B) a semiconductive conductor shield;
(C) an insulation layer;
(D) a semiconductive insulation shield; and
(E) a jacket comprising
(i) a low-smoke, non-halogenated flame retardant composition comprising:
(a) a first ethylene/vinyl acetate copolymer, having a total content of vinyl acetate-derived units in an amount from about 15 to about 45 weight percent, based upon the total weight of the ethylene/vinyl acetate copolymer;
(b) a coupling agent;
(c) magnesium dihydroxide;
(d) hydromagnesite; and
(e) huntite.
